(19) United States
(12) Patent Application Publication
(10) Pub. No.: US 2025/0154819 A1
(43) Pub. Date: May 15, 2025

(54) Automatically Opening a Cover of a Charging Connection

(71) Applicant: Bayerische Motoren Werke Aktiengesellschaft, Muenchen (DE)

(72) Inventors: Sascha BRINKMANN, Muenchen (DE); Alexander EWALD, Muenchen (DE)

(21) Appl. No.: 18/837,302

(22) PCT Filed: Feb. 14, 2023
(86) PCT No.: PCT/EP2023/053552

§ 371 Date: Aug. 9, 2024

(30) Foreign Application Priority Data
Feb. 15, 2022 (DE) 10 2022 103 540.9

(51) Int. Cl. E05F 15/77; B60L 53/30; B60L 53/66

(52) U.S. Cl. CPC E05F 15/77; B60L 53/305; B60L 53/66; E05Y 2900/534

(57) ABSTRACT

A method automatically opens a cover of a charging connection of an electric vehicle. The method, after the electric vehicle is brought into a parked state which is suitable for charging via a charging connection, uses wirelessly received signals which identify charging stations in order to check whether a charging station has recently been brought to its charging state, and if so, the cover of the charging connection automatically opens. A charging station is equipped with a radio beacon, in particular a Bluetooth beacon, which is active whenever the charging station is in its charging state in order to transmit signals that identify the charging station.

### BACKGROUND AND SUMMARY

The invention relates to a method for automatically opening a cover of a charging connection of an electric vehicle. The invention also relates to an electric vehicle that is designed to carry out the method. The invention additionally relates to a charging station that is designed to carry out the method. The invention furthermore relates to a system comprising at least one such electric vehicle and at least one such charging station.

U.S. Pat. No. 8,627,860 B2 discloses a fuel feeding system and a method for the use thereof that can be used to open the flap that covers a charging connection of an electric vehicle. The system comprises a charging connection designed to transmit electrical energy from the source to the vehicle via the charging connection of the vehicle. The charging connection contains a switch that causes a control signal to be transmitted wirelessly over a short distance when the switch is switched over. When a receiver that is integrated into a vehicle located in the immediate vicinity of the charging connection receives the control signal, an unlocking actuator within the vehicle unlocks the flap, which enables it to open and provide access to the charging connection.

EP 3 257 696 A1 relates to a method and a corresponding apparatus for operating a cover of a charging connection of a vehicle, wherein one or more conditions that indicate an imminent fueling or charging process are detected, and wherein the cover is opened automatically if the one or more conditions are detected.

U.S. Pat. No. 10,974,605 B2 discloses a method for charging an electric vehicle. The method comprises an electric vehicle receiving a wireless signal that is assigned to an electric vehicle charging apparatus. When the signal is received, the method comprises controlling an actuator in order to open, depending on the reception of the wireless signal, a housing that contains a charging socket for receiving the charging plug.

DE 10 2012 021 518 A1 discloses a method for supporting a fueling/charging process of an energy store of a vehicle, proposed having at least the following steps: automatically detecting an energy delivery device in the region of a supply opening of the energy store of the vehicle, and, in response to the detection, automatically opening a closure element of the supply opening such that the position of the closure element allows the energy delivery device to be connected. The method is characterized in that the energy delivery device is detected by means of optical and/or radio-supported detection. The invention further relates to a method for supporting a fueling/charging process of an energy store of a vehicle, proposed comprising at least the following steps: automatically detecting a predefined motion pattern, preferably a predetermined motion of a hand, in the region of a supply opening of the energy store of the vehicle, and, in response to the detection, automatically opening a closure element of the supply opening such that the position of the closure element allows an energy delivery device to be connected. Also proposed is respective automatic detection of the removal of the operator control element of the energy delivery device from the region of the supply opening and/or automatic detection of an additional predetermined motion pattern in the region of the supply opening and automatic closing of the closure element such that the supply opening is closed.

US 2017/0259678 A1 discloses movable charging connection systems for electric vehicles. An electric vehicle may have a charging connection that can couple to a charging station and receive electrical energy therefrom. The charging connection may be arranged in a concealed position so as to be movable and may be configured to move from the hidden position to an exposed position in order to allow it to be coupled to the charging station. The vehicle may include a motor that is set up to move the charging connection from the hidden position to the exposed position and a processing circuit that is configured to command the motor to move the charging connection. The charging connection may be moved to the exposed position automatically in response to the detection of the presence of a charging station in the vicinity.

The object of the present invention is to at least partly overcome the disadvantages prior art and in particular to provide an easily implementable and cost-effective option for automatically opening a cover of a charging connection of an electric vehicle that better prevents unwanted opening.

This object is achieved according to the features of the independent claims.

Preferred embodiments can be gathered in particular from the dependent claims.

The object is achieved by a method for automatically opening a cover of a charging connection of an electric vehicle, in which the electric vehicle,
after it has been brought to a parked state that is suitable for charging via the charging connection of the vehicle, uses wirelessly received signals that identify charging stations in order to check whether a charging station has recently been brought to its charging state,
and, if this is the case, the cover of the charging connection opens automatically.

This results in the advantage that the cover is opened only if a charging station located in the surroundings of the electric vehicle has recently been brought to its charging state, which is typically the case when a user gets out after parking the electric vehicle and establishes a connection between the charging station and the charging connection of the electric vehicle via a charging cable in order to charge, discharge or condition an electrical storage unit of the electric vehicle. Charging stations that are already in their charging state upon parking are ignored and advantageously cannot trigger the opening of the cover.

The charging connection may be in particular any connection that is set up to connect a charging cable thereto. The charging connection may also be referred to as a charging socket or vehicle inlet.

The cover may be any mechanical cover that blocks access to the charging connection in its closed state. The cover may be for example a flap (“charging flap”). The cover may be operatively connected in particular to an electrically controllable opening mechanism that is set up to open the cover upon reception of a corresponding control signal of the electric vehicle. The opening may include unlocking and/or, particularly advantageously, movement of the cover until the charging connection is fully uncovered. The opening mechanism may have for example at least one electric motor or electrically activatable actuator as drive.

One development is that the cover is set up to close the cover upon reception of a corresponding control signal of the electric vehicle.

An electric vehicle may be understood to mean in particular a partly electrically driven vehicle (for example a “plug-in hybrid electric vehicle”, PHEV) or a fully electrically driven vehicle (“battery electric vehicle”, BEV), for example a corresponding automobile, motorcycle, minibus, bus, etc.

A parked state is understood to mean a state of the electric vehicle in which it is ready for connection of a charging cable and/or for charging, discharge (for example V2G) or conditioning of the electrical energy storage unit thereof (referred to in the following text without restricting the generality as “battery”, in particular “drive battery”). The parked state may include for example the electric vehicle being parked. The fact that the electric vehicle has been brought into a parked state that is suitable for charging via the charging connection thereof may then include for example the fact that it has been parked.

The electric vehicle is set up to wirelessly receive signals and to this end comprises at least one appropriate signal receiver. The signals may include for example radio or IR signals.

The fact that the wirelessly received signals are signals that identify charging stations includes in particular the fact that the signals include a piece of information that they characterize as originating from a particular charging station. The information may include for example an identification that it relates to a signal that is output by a charging station and an individual identifier that distinguishes this charging station from other charging stations at least in the vicinity. The piece of information may be an EVSE ID. This identification of the charging stations enables the electric vehicle to assign signals transmitted simultaneously within a particular period two different charging stations and thus to identify which charging stations are in their charging state at a particular time.

The fact that a charging station is in its charging state may include in particular the fact that the charging station has been set up to begin or to end a charging process. A charging station may be in its charging state for example if:
a charging cable attached thereto is removed from its holder;
an external charging cable (for example of an electric vehicle) is connected to a charging cable connection of the charging station.

A charging station may be for example a charging column or a charging point, in particular at a public charging site.

The fact that the electric vehicle uses the received signals to check whether a charging station has recently been brought to its charging state includes the fact that the electric vehicle checks, for example scans, after it has been brought to its part state, whether signals from at least one charging station that have not yet been received previously (for example immediately after the parked state) have recently been received. This characteristic utilizes the knowledge that a free charging station does not transmit any signals that indicate its charging state immediately after the electric vehicle has been brought to its parked state in the vicinity of the charging station. Only when a user gets out of the vehicle and subsequently takes a fixedly attached charging cable out of the holder of the charging station or connects their charging cable that they have brought themselves to the charging station with an appropriate time delay is the signal indicating the charging state output by the charging station. The electric vehicle can then recognize, by checking the received signals, that a charging station in the vicinity of the electric vehicle has recently been brought to the charging state. Since it is extremely likely that this involves the charging station selected by the user of the electric vehicle for charging, discharge or conditioning, the cover is opened purposefully so that the user of the electric vehicle can connect the charging cable to the charging connection of the electric vehicle without having to perform an action intended for opening the cover themselves, that is to say automatically or without additional operating steps. This in turn increases user friendliness and thus user satisfaction.

One development is that the cover can additionally be opened by means of other mechanisms, for example opening the cover by pressing a button on the charging flap, by pressing a button on the charging plug and/or by way of operator control steps in the CID (“center instrument display”) or in an app. This is advantageous if the charging station(s) in the vicinity of the electric vehicle is (are) not equipped to output signals indicating the charging state of the type described above.

One configuration is that, after it has been brought to its parked state, the electric vehicle first or initially checks which charging station(s) is (are) already in its (their) charging state and the cover of the charging connection opens automatically if it is subsequently identified that a charging station has recently been brought to its charging state. This allows a particularly easily implementable and reliable option for identifying whether a charging station has recently been brought to its charging state.

One configuration is that the electric vehicle checks for a predetermined first period which charging station is already in its charging state. This achieves the advantage that charging stations that are already in their charging state can be identified particularly reliably.

One development is that the predetermined first period is a predetermined period of time, for example from 1 s to 2 s, that is matched in particular to the repetition frequency of the signals that are output by the charging stations. One development is that the predefined first period corresponds to a minimum nominal repetition frequency (for example from 1 signal per s), such that a signal from a charging station in its charging state should then be received at least once. One development is that the predefined first period corresponds to a multiple of a minimum nominal repetition frequency, which allows the charging station(s) in its (their) charging state to be determined particularly reliably. A signal from a charging station in its charging state should then be received multiple times. However, it is also possible that the predetermined first period is a variable period, for example the period required to receive at least one signal twice, three times or even more often. One development is that the predetermined first period is markedly shorter than a typical period between parking an electric vehicle and removing the charging cable from its holder or plugging a charging cable into a charging cable connection of the charging station.

One development is that the electric vehicle scans for the signals described above periodically, for example every second, or carries out a scanning process approximately every second.

One development is that the electric vehicle checks whether a charging station has recently been brought to its charging state between being brought to its parked state and the parked state being ended (for example due to moving off).

One development is that the electric vehicle checks with an increased frequency (“scan rate”) whether a charging station has recently been brought to its charging state after being brought to its parked state for a predetermined second period. In particular, the scan rates can subsequently be reduced. One development is that the higher scan rate is for example 1 scan per second or 2 scans per second.

One configuration is that, after it has been brought to its parked state, the electric vehicle checks only for a predetermined second period whether a charging station has recently been brought to its charging state.

One development is that the second period is between 5 min and 10 min, for example approximately 10 min.

One configuration is that the signals are short-range signals, in particular with a range of not more than 10 m. This achieves the advantage that charging stations located beyond a typical length of charging cables are not identified and thus not taken into account for opening the cover. This in turn further reduces the likelihood of an incorrectly triggered opening.

One configuration is that the signals are Bluetooth radio signals. These can advantageously be limited to a short range, can carry the required information easily and are widespread in terms of their application. Modern electric vehicles often already have at least one Bluetooth receiver installed, which results in a particularly cost-effective implementation of the method.

One configuration is that the cover is automatically closed again (in particular if it has not already otherwise been closed) if a charging cable has not been plugged into the charging connection within a predetermined third period after the cover has been opened. This takes into account the case where a user does not connect a charging cable to the electric vehicle after the charging station has been brought to its charging state or the cover has been opened incorrectly. The third period is in principle able to be set as desired, but is advantageously in the range of minutes, for example it may be between 1 min and 5 min, specifically approximately 2 min.

One configuration is that the cover is automatically closed again (in particular if it is not already otherwise been closed) after a predetermined fourth period after a charging process is ended. This achieves the advantage that the closing process also proceeds automatically, which further increases user convenience. The fourth period may be for example between 2 s and 30 s, in particular between 5 s and 10 s.

The end of the charging process may for example correspond to:
removal of a previously inserted charging cable from the charging connection of the electric vehicle,
removal of a previously inserted charging cable from the charging cable connection of the charging station and/or
hanging of the charging cable in a holder of the charging station.

In one development, the charging station stops transmitting signals when the charging process ends. The absence of the signals is identified by the vehicle, which subsequently automatically closes the cover again after the fourth period.

In another development, the charging station transmits signals irrespective of its charging state. The signals carry information about the charging state, in particular about whether or not the attached charging cable is in its holder or whether or not an external charging cable is connected to the charging cable connection of the charging station. The information about the end of the charging process is read by the electric vehicle, which then automatically closes the cover again after the fourth period when the information relating to the end of the charging process changes.

For the case where the end of the charging process is determined by a previously inserted charging cable being removed from the charging connection of the electric vehicle, this may also be determined for example by simple plug identification at the charging connection.

The object is also achieved by an electric vehicle that is designed to carry out the method as described above.

The object is achieved in particular by an electric vehicle comprising a charging connection having a cover that can be opened automatically, a signal receiver set up for wireless reception of electromagnetic signals and a control device set up to evaluate the signals received by the signal receiver and set up to automatically open the cover, wherein the control device is set up to run the method as described above.

The electric vehicle may be designed analogously to the method, and vice versa, and has the same advantages.

The cover may thus be for example a charging flap that covers a charging socket of the electric vehicle.

Furthermore, the signal receiver may be for example a Bluetooth receiver or Bluetooth transceiver. One development is that a Bluetooth receiver that is already present in an electric vehicle, in particular a Bluetooth transceiver, can be or has been retrospectively reprogrammed to carry out the method. The option to retrofit existing electric vehicles to use the present method is very especially cost-effective.

The cover may be opened using a motor or actuator. The electric vehicle may be a PHEV or BEV.

The control device may be an on-board computer of the electric vehicle.

The object is furthermore achieved by a charging station for charging electric vehicles that is designed to carry out the method as described above.

The object is achieved in particular by a charging station equipped with a radio beacon that transmits signals that identify the charging station, and the radio beacon is set up to transmit the signals in accordance with the charging state of the charging station.

The charging station may be designed analogously to the method, and vice versa, and has the same advantages.

It is thus one configuration that the radio beacon is activated to transmit signals that identify the charging station whenever the charging station is in its charging state, otherwise it is deactivated. This enables particularly energy-saving operation.

One configuration is that, irrespective of the presence of the charging state, the radio beacon is set up to transmit signals carrying appropriately readable information depending on the presence or absence of the charging state. This is particularly advantageous for also transmitting, in particular bidirectionally, other information via the radio beacon or a radio emitter, in particular radio transceiver (see also further below), that also can be used as a radio beacon.

One configuration is thus that the charging station is equipped with a Bluetooth beacon that is set up to transmit Bluetooth signals at a short range, for example of not more than 10 m. One development is that the Bluetooth beacon is a Bluetooth low energy (LE) beacon. Bluetooth beacons are fundamentally known Bluetooth radio transmitters that transmit their universally unique identifier via broadcast.

One development is that the charging station has an attached charging cable that is held in a holder when the charging station is in the rest state. One development that the holder has an assigned sensor, by means of which it is possible to determine whether or not the charging cable is in the holder. The sensor may be for example a magnetic switch or magnetic contact switch.

One development is that the charging station has a charging cable connection for connecting an external charging cable. One development is that the charging cable connection has an assigned sensor, by means of which it is possible to determine whether or not a charging cable is connected to the charging cable connection. The sensor may be for example a magnetic switch or magnetic contact switch.

One development is that the charging station has a Bluetooth transmitter that can be used or is set up as a Bluetooth beacon but can also be used for other communication. The Bluetooth transmitter is in particular a Bluetooth transceiver and thus suitable for bidirectional communication via Bluetooth. This results in the advantage that Bluetooth transmitters, in particular Bluetooth transceivers, that are already present in many charging stations can also be used as Bluetooth speakers, which enables the method to be implemented particularly cost-effectively. One development is that a Bluetooth transmitter, in particular a Bluetooth transceiver, that is already present in a charging station can be or has been retrospectively reprogrammed for use as a Bluetooth beacon. The option to retrofit existing charging stations to use the present method is very especially cost-effective.

The type of charging station is not limited and may include for example a rapid-charging station as well.

The object is furthermore achieved by a system comprising at least one electric vehicle as described above and at least one charging station as described above.

The system may be designed analogously to the method, the electric vehicle, and the charging station, and vice versa, and has the same advantages.

The at least one charging station may include in particular multiple charging stations. The charging stations may be located for example in a public or private charging park, a parking garage, etc.

The above-described properties, features and advantages of this invention and the way in which they are achieved will become clearer and more clearly understood in association with the following schematic description of an exemplary embodiment which will be explained in greater detail in association with the drawing.

### BRIEF DESCRIPTION OF THE DRAWING

FIG. 1 is a flow chart and schematic diagram illustrating a possible sequence for automatically opening and closing a cover of a charging connection of an electric vehicle.

### DETAILED DESCRIPTION OF THE DRAWING

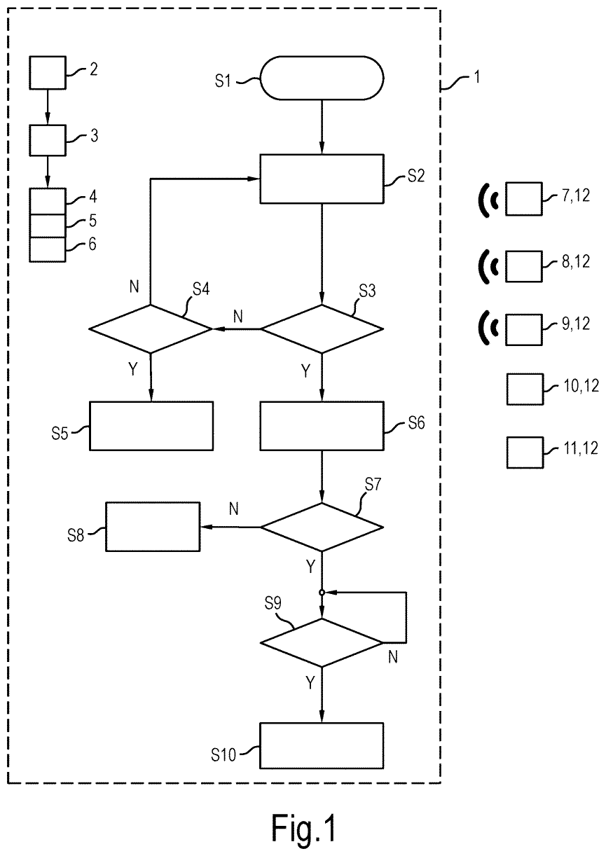

FIG. 1 shows a possible sequence for automatically opening and closing a cover of a charging connection of an electric vehicle 1. The electric vehicle 1 comprises a Bluetooth transceiver 2, a control device 3 coupled thereto in terms of data technology, and a drive unit 4 coupled to the control device 3 and designed to use a motor or actuator to open and close a charging flap 5 that covers a charging socket 6 of the electric vehicle 1. A drive battery (top of figure) of the electric vehicle 1 may be charged, discharged or conditioned by way of the charging socket 6.

In a step S1, the electric vehicle 1 is brought to a parked state that is suitable for charging the drive battery by means of the charging socket 6 thereof, for example is parked.

In a step S2 directly following step S1, the Bluetooth transceiver 2 is used to scan whether Bluetooth signals (Bluetooth beacon signals) that have been transmitted by Bluetooth beacons 12 installed in charging stations 7, 8, 9, 10, 11 and that carry a unique identifier are received. Of the charging stations 7 to 11 shown, it is assumed that the charging stations 7 and 8 are already in their charging state when the initial scan is carried out, for example because the attached charging cables thereof have been removed from the associated holders. In contrast, the charging stations 9 to 11 do not transmit any Bluetooth beacon signals because they are not in the charging state, for example because the attached charging cables thereof are still in the associated holders. As an alternative to transmitting/not transmitting signals, signals that are permanently transmitted by the charging stations 7 to 11 may contain a corresponding piece of information about the respective charging state.

In a step S3, a check is then carried out to determine whether a charging station has recently been identified, that is to say only after the initial scan has been carried out. To this end, the Bluetooth transceiver 2 can be used to perform appropriate scans for Bluetooth beacon signals at a high frequency of, for example, one scan per second. This may be implemented for example by virtue of a Bluetooth beacon signal with an identifier that has not yet been used in the initial scan being identified.

If a charging station 9 to 11 has not recently been identified (“N”) in step S3, a check is subsequently carried out in step S4 to determine whether a predetermined second period since the electric vehicle 1 was parked has passed, for example 10 min. If this is still not the case (“N”), there is a return back to step S2.

However, if this is the case (“Y”), the method ends in a step S5 without the charging flap 5 having been opened. However, the charging flap 5 may continue to be opened using other methods, for example manually, by means of a CID of the electric vehicle 1, an app, etc.

However, if a charging station, in this case by way of example the charging station 9, has recently been identified based on its identifier (“Y”) in step S3, the charging flap 5 is opened immediately in step S6 by virtue of the control device 3 outputting a corresponding command or a corresponding control signal to the drive unit 4.

Following step S6, a check is carried out in a step S7 to determine whether a charging cable has been plugged into the charging socket 6 within a predetermined third period of, for example, 2 minutes after the cover was opened. If this is not the case (“N”), the charging flap 5 is automatically closed again in step S8 by virtue of the control device 3 outputting a corresponding command or a corresponding control signal to the drive unit 4.

However, if this is the case (“Y”), a check is carried out in a step S9 to determine whether the charging process is ended. This may be determined for example by virtue of a user unplugging the charging cable from the charging socket 6 and inserting it back into the holder of the charging station 9. The charging station 9 then stops the transmission of the Bluetooth beacon signals. The absence of the Bluetooth beacon signals with the identifier based on which the charging flap 5 has been opened is identified by the control device 3 and interpreted as the end of the charging process.

If the charging process has not yet ended (“N”), the check in step S9 is continued.

However, if the check based on step S9 has revealed that the charging process has been ended (“Y”), the charging flap 5 is automatically closed again in step S10 after a predetermined fourth period of, for example, 2 s to 5 s.

It goes without saying that the present invention is not restricted to the exemplary embodiment shown.

The beacon/signal transmitter of the charging station can thus not only be activated or deactivated based on the presence of the charging state, but the beacon/signal transmitter can also transmit signals—in particular continuously—irrespective of the presence of the charging state, these signals carrying a corresponding readable piece of information depending on the presence or absence of the charging state, however.

Generally speaking, “a”, “an”, “one” etc. may be understood to mean a single number or a multiplicity, in particular in the sense of “at least one” or “one or more” etc., provided that this is not explicitly ruled out, for example by the expression “exactly one”, etc.

A numerical specification may also comprise precisely the specified number and a conventional tolerance range, provided that this is not explicitly ruled out.

### LIST OF REFERENCE SIGNS

1 Electric vehicle
2 Bluetooth transceiver
3 Control device
4 Drive unit
5 Charging flap
6 Charging socket
7-11 Charging stations
12 Bluetooth beacon
S1-S10 Method steps

1.-14. (canceled)

15. A method for automatically opening a cover of a charging connection of an electric vehicle, the method comprising:
after the electric vehicle has been brought to a parked state suitable for charging via the charging connection of the vehicle, checking whether a charging station has recently been brought to its charging state, based on wirelessly received signals that identify charging stations; and
when a charging station has recently been brought to its charging state, automatically opening the cover of the charging connection.

16. The method according to claim 15, wherein
the electric vehicle first checks which charging station is already in its charging state, and
the cover of the charging connection opens automatically when it is subsequently identified that a charging station has recently been brought to its charging state.

17. The method according to claim 16, wherein
the electric vehicle first checks, for a predetermined first period, which charging station is already in its charging state.

18. The method according to claim 15, wherein
the wirelessly received signals are short-range signals.

19. The method according to claim 18, wherein
the wirelessly received signals are Bluetooth radio signals.

20. The method according to claim 17, wherein
after the electric vehicle has been brought to its parked state, the electric vehicle checks at an increased frequency for a predetermined second period whether a charging station has recently been brought to its charging state.

21. The method according to claim 17, wherein
after the electric vehicle has been brought to its parked state, the electric vehicle checks, only for a predetermined second period, whether a charging station has recently been brought to its charging state.

22. The method according to claim 15, wherein
the cover is automatically closed again if a charging cable has not been plugged into the charging connection within a predetermined third period after the cover is opened.

23. The method according to claim 15, wherein
the cover is automatically closed again after a predetermined fourth period after a charging process has ended.

24. An electric vehicle, comprising:
a charging connection having a cover that is openable automatically;
a signal receiver configured for wireless reception of electromagnetic signals; and
a control device configured to evaluate the electromagnetic signals received by the signal receiver,
wherein the control device is configured to:
after the electric vehicle has been brought to a parked state suitable for charging via the charging connection of the vehicle, checking whether a charging station has recently been brought to its charging state, based on the electromagnetic signals that identify charging stations; and
when a charging station has recently been brought to its charging state, automatically opening the cover of the charging connection.

25. A charging station for charging electric vehicles, comprising:
a radio beacon that transmits signals that identify the charging station, wherein
the radio beacon is configured to transmit the signals in accordance with a charging state of the charging station.

26. The charging station according to claim 25, wherein
the radio beacon is activated to transmit signals that identify the charging station whenever the charging station is in its charging state.

27. The charging station according to claim 26, wherein
irrespective of a presence of the charging state, the radio beacon is configured to transmit signals carrying a corresponding readable piece of information depending on a presence or absence of the charging state.

28. The charging station according to claim 27, wherein
the charging station is in its charging state when a charging cable attached thereto is removed from a holder and/or an external charging cable is plugged into a compatible charging cable connection of the charging station.

29. A system, comprising:
at least one electric vehicle comprising a charging connection having a cover that is openable automatically, a signal receiver configured for wireless reception of electromagnetic signals, and a control device configured to evaluate the electromagnetic signals received by the signal receiver;
at least one charging station comprising a radio beacon that transmits the electromagnetic signals that identify the charging station, wherein the radio beacon is configured to transmit the signals in accordance with a charging state of the charging;
wherein the control device of the electric vehicle is configured to:
after the electric vehicle has been brought to a parked state suitable for charging via the charging connection of the vehicle, checking whether a charging station has recently been brought to its charging state, based on the electromagnetic signals that identify charging stations; and
when a charging station has recently been brought to its charging state, automatically opening the cover of the charging connection
